(19) United States
(12) Patent Application Publication
(10) Pub. No.: US 2009/0323372 A1
(43) Pub. Date: Dec. 31, 2009

(54) Device and display device using the same

(76) Inventors: Makoto Kurihara, Chiba-shi (JP); Masashi Ono, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/456,976

(22) Filed: Jun. 25, 2009

(30) Foreign Application Priority Data
Jun. 27, 2008 (JP) 2008-168650
Feb. 6, 2009 (JP) 2009-026513
Apr. 24, 2009 (JP) 2009-106756

(51) Int. Cl. F21V 7/22; G02F 1/13357

(52) U.S. Cl. 362/620; 362/617; 362/97.1

(57) ABSTRACT

Provided is a lighting device that inputs a light from a light source from a side surface of a light guide body, and outputs the light from an upper surface of the light guide body, in which a recess is formed on a light input surface of a light guide plate so as to face the light source, and a paraboloid extending in a radial pattern in a light output direction from a light output part of the light source is connected to the light input surface. Prisms arranged on a light output surface of the light guide body are disposed up to an area closest to the light source wherever possible. With the above-mentioned configuration, an output of the light of components perpendicular to the light output surface of the light guide body remarkably increases, and brightness of the lighting device can be enhanced without using a prism sheet.

### BACKGROUND OF THE INVENTION

The present invention relates to a lighting device and a display device using the lighting device. In particular, the present invention relates to a lighting device such as a front light or a back light which illuminates a non-self light emission display element, and to a liquid crystal display device for use in a portable information device, a notebook PC, a cellular phone, or a liquid crystal television. Further, the present invention relates to an equipment lighting device for housings, offices, or the like.

Up to now, there has been known a lighting device of an edge light system which inputs a light emitted from a light source from a side surface of a light guide body, and outputs the light from an upper surface (hereinafter referred to as “light output surface”) of the light guide body. A point light source such as a light emitting diode (LED) is used for the light source, and a large number of grooves or dot patterns are formed on a lower surface (opposing surface) of the light guide body opposite to the light output surface. Further, a diffusion pattern that diffuses the light is frequently formed on the light output surface. A prism is formed on a light input surface (that is, a surface which faces the light source and to which the light is input from the light source) of the light guide body. The prism allows the light of the point light source to be so diffused as to be input to an interior of the light guide body. A material of the light guide body to be used is a transparent resin such as polycarbonate (PC) or acrylic (PMMA) higher in refractive index than air. Further, in general, a diffusion sheet or a prism sheet is arranged on the light output surface side of the light guide body. Further, a reflective sheet is arranged on a lower portion of the light guide body.

Further, there has been known a lighting device of an edge light system using not the point light source but a line light source such as a cold cathode tube (for example, refer to JP 9-292531 A). Further, there has been known a lighting device high in utilization efficiency of light in which the point light source and the light guide body that has been subjected to micro prism processing are combined together (for example, refer to JP 2006-4915 A).

In the conventional lighting devices, in order to uniformly scatter the light emitted from the light output surface of the light guide body, an optical design is made such that the light is output while repeating reflection and refraction within the light guide body. However, when the numbers of reflection and refraction increase, the light to be attenuated increases correspondingly, resulting in a deterioration of the utilization efficiency of light.

In particular, when the point light source such as the LED is used, the light from the point light source is input to the light guide body after the light has been diffused by the prism or the diffusion layer once. For that reason, unnecessary reflection and refraction increase similarly to the interior of the light guide body, and the utilization efficiency of light is deteriorated.

Now, a description is given of a lighting device configured such that the light emission of the point light source is input to the light input surface of the light guide body without being diffused. FIG. 9 schematically illustrates an optical path of light within the light guide body when a light from a light source 1 is input to a light guide plate as it is. The light from the light source 1 generally has a wide light distribution characteristic, and scatters in a range of substantially 180 degrees. The light output from the light source 1 can be roughly classified into linear components 3a perpendicular to a lower prism 5 of a light guide body 2, and oblique components 3c angled to the lower prism 5. The probability is high that the linear component 3a is applied onto the reflection surface of the lower prism 5 at a critical angle, and the linear components are liable to be totally reflected. For that reason, the linear components are liable to travel out of the light guide body 2. Moreover, the linear component is liable to be output as a light perpendicular to the light output surface. On the other hand, the oblique components 3a have a smaller amount of components that are reflected from the lower prism 5 even if the components are applied thereto. That is, in the case of the light guide body in which a reflection structural body such as the prism is formed, when there are a large amount of oblique components, the output efficiency from the light guide body is deteriorated.

Further, in order to enhance uniformity of a surface emission, a diffusion film or a prism sheet is frequently disposed on the light guide body. The films of those types cause an increase in thickness and costs of the lighting device.

Further, the lighting device into which the point light source and the light guide body that has been subjected to micro prism processing are combined together suffers from a problem that it is difficult to increase size of the light guide plate.

### SUMMARY OF THE INVENTION

The present invention aims at realizing a lighting device and a display device which are high in utilization efficiency of light, and are capable of being thinned and increased in size. According to the present invention, there is provided a lighting device including a light source and a light guide body that guides a light from the light source to output the light from an upper surface thereof, in which a recess is formed on a light input surface to which the light from the light source is input so as to face the light source, and a paraboloid extending in a radial pattern in a light output direction from a light output part of the light source is connected to the light input surface. Further, prisms arranged on the upper surface of the light guide body that outputs the light from a light input part are disposed up to an area closest to the light source wherever possible.

According to the present invention, an output of light components perpendicular to a light output surface of the light guide body remarkably increases, and even the light guide body of a point light source such as an LED enables brightness to be increased without using a prism sheet. For that reason, there can be realized the lighting device and the display device which are capable of being high in brightness, inexpensive, and thin, and of being increased in size.

### BRIEF DESCRIPTION OF THE DRAWINGS

In the accompanying drawings:

FIG. 1 is a schematic diagram illustrating a configuration of a lighting device according to a first embodiment of the present invention;

FIG. 2 is an enlarged diagram for illustrating a light input part of the lighting device according to the first embodiment of the present invention;

FIG. 3 is a schematic diagram illustrating a cross-sectional configuration of the lighting device according to the first embodiment of the present invention;

FIG. 4 is a schematic diagram illustrating a cross-sectional configuration of a lighting device according to a second embodiment of the present invention;

FIG. 5 is a schematic diagram illustrating a part of the configuration of the lighting device according to the first embodiment of the present invention;

FIG. 6 is a schematic diagram illustrating a part of a configuration of a lighting device according to a third embodiment of the present invention;

FIG. 7 is a schematic diagram illustrating a configuration of a lighting device according to a fourth embodiment of the present invention;

FIG. 8 is a schematic diagram illustrating another cross-sectional configuration of the lighting device according to the first embodiment of the present invention;

FIG. 9 is an enlarged diagram schematically illustrating a part of a configuration of a conventional lighting device;

FIG. 10 is an enlarged diagram schematically illustrating a part of the configuration of the lighting device according to the first embodiment of the present invention;

FIG. 11 is a schematic diagram illustrating a configuration of a lighting device according to a fifth embodiment of the present invention;

FIG. 12 is a schematic diagram illustrating another configuration of a lighting device according to the fifth embodiment of the present invention;

FIG. 13 is a schematic diagram illustrating a configuration of a lighting device according to a sixth embodiment of the present invention; and

FIG. 14 is an enlarged diagram for illustrating a light input part of a lighting device according to a seventh embodiment of the present invention.

### DETAILED DESCRIPTION OF THE PREFERRED EMBODIMENTS

A lighting device according to the present invention is described with reference to FIG. 1. FIG. 1 is a top view illustrating a configuration of the lighting device according to the present invention. As illustrated in FIG. 1, a plurality of light sources 1 each emitting a light, and a light guide body 2 that guides the light from each light source 1 and emits the light from a light output surface thereof are arranged close to each other. The light guide body 2 can be roughly classified into a plurality of light input parts 2a and a light emitting part. The light guide body 2 guides the light input from a light input surface of each light input part 2a, and outputs the light from the light output surface of the light emitting part. Each of the light input parts 2a has the light input surface that faces a light output part of the light source 1, and a paraboloid formed in a radial pattern in a light output direction from the light output part of the light source 1. A recess is formed in the light input surface of each light input part 2a so as to face the light output part of the light source 1. It is desirable that a configuration of the recess be trapezoidal, but the recess may be configured in a half circle, a triangle, or a polygon. As illustrated in FIG. 1, when the plurality of light sources are provided, the paraboloid is formed at the light input parts 2a facing an interval between the respective light sources 1. In this way, each of the light input parts 2a is configured by the light input surface formed with the recess, and the paraboloids, with the result that the light of the light sources which are emitted over a wide range can be uniformed in a given direction so as to be introduced into the light guide plate 2. Further, the light guide body 2 is formed with a reflection structural body that allows the light input from the light input surface to be output from the light output surface.

Further, the light output surface of the light guide body 2 may be formed with an upper prism being substantially at a right angle with respect to the light input surface of the light guide body 2. Alternatively, a plurality of upper prisms may be formed to cross each other. The upper prism has the effect of reducing unevenness of the light output surface. A vertex angle of the upper prism formed on the light output surface is within a range of from 40° to 170°. Further, the vertex angle of the upper prism is not limited to one type, but the upper prisms having a plurality of different vertex angles may be arranged. As a cross-sectional configuration of the upper prism, a triangular prism or a semi-circular prism can be exemplified. Further, the upper prism may be configured by two or more types of different cross-sectional configurations. Alternatively, the upper prism may be formed so that a height of the upper prism becomes lower as the upper prism is spaced apart from the light source.

It is desirable that the upper prism be formed on not only the entire surface of the light emitting part of the light guide body 2 but also the light input part, and the upper prism may be preferably formed at a position closest to the light source wherever possible. In this case, the light input part is formed with a prism that is different in configuration from the prism formed on the light output surface of the light emitting part. The upper prism formed on the light input part is so configured as to uniform the directions of light output from the light input part, and the upper prism formed on the light emitting part is so configured as to reduce the unevenness of the light output surface.

Further, an opposing surface of the light guide body 2 may be formed with a prism or a dot as the reflection structural body. In this situation, pitches of the reflection structural body are set to regular, and heights thereof are changed. That is, the heights of the reflection structural body are increased more as the reflection structural body is spaced apart from the light source. Conversely, it is possible that the heights of the reflection structural body are held constant, and the pitches are variable. That is, the pitches of the reflection structural body are narrowed more as the reflection structural body is spaced apart from the light source.

Further, the opposing surface of the light guide body 2 is formed with structures for suppressing a total area of the reflection surfaces of the reflection structural body. Each of the structures is of a convex configuration or a concave configuration each having a longitudinal in parallel to the light output direction of the light source, and a plurality of the structures are arranged on the opposing surface. The plurality of structures may be arranged as given pitches. Further, a cross-sectional area of each structure is smaller as the structure is spaced apart from the light source.

Further, a display device is configured using the light device having any one of the above-mentioned configurations, and a non-self light emission display element.

### First Embodiment

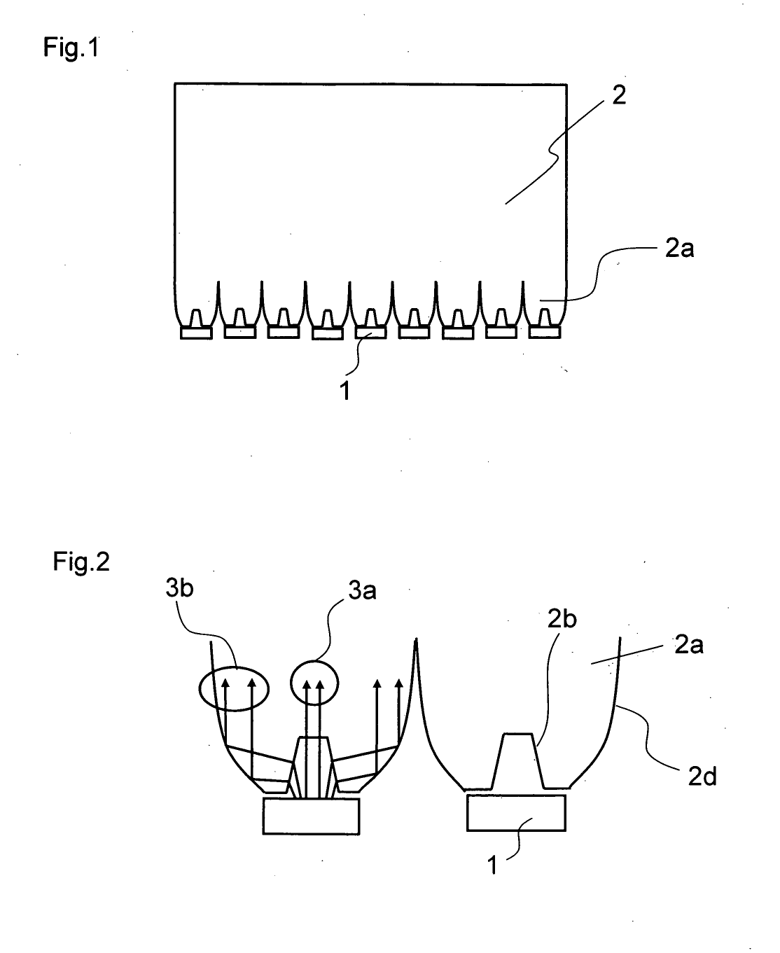

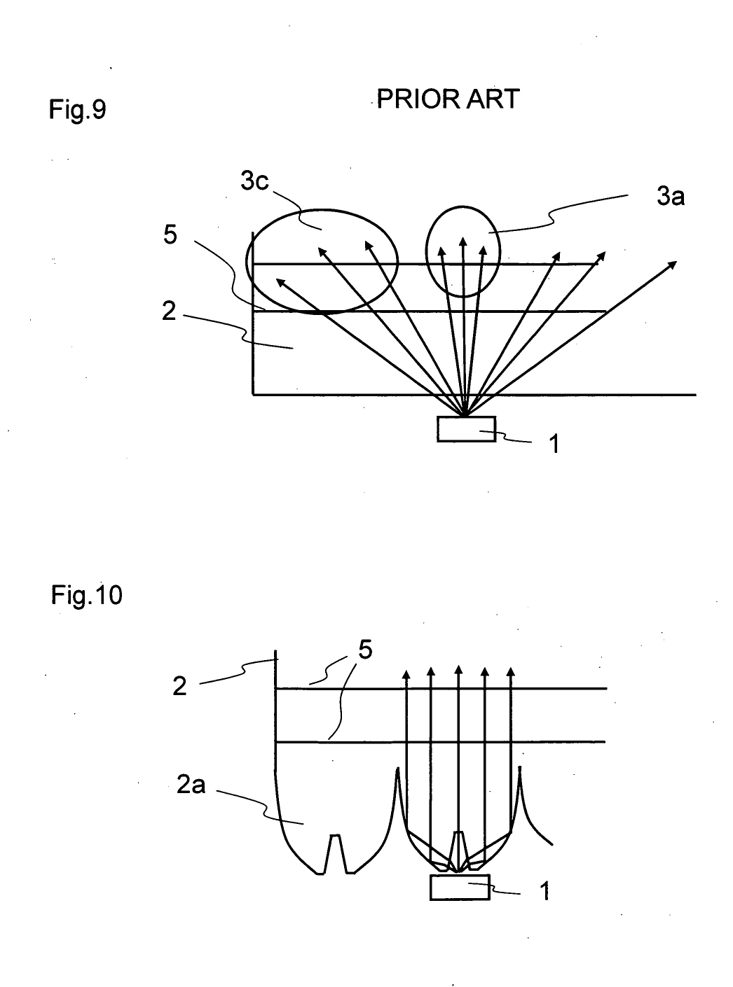

A first embodiment is described with reference to FIGS. 2, 3, 5, and 8 to 10. FIG. 2 illustrates an enlarged configuration of the light input parts 2a of the light guide body 2. As illustrated in FIG. 2, each of trapezoidal recesses 2b is formed on the light input surface facing each light source 1. A short side of the trapezoid is about 0.2 to 0.6 mm, a long side is about 1.0 to 1.2 mm, a height is about 0.5 to 1.0 mm, and optimum values thereof depend on a light distribution characteristic of the light source 1, etc. Further, a paraboloid 2d is extended in a radial pattern along the light output direction from the light output part of each light source 1. The curve of the paraboloid 2d is determined according to a focal position of a parabola forming the paraboloid 2d, and the focal position is within a range of from about 0.5 to 0.7 mm, horizontally along the light output surface from the light source 1. The configuration of the recess, the parabola, and the focal position thereof are optimized in conformity to the light distribution characteristic of the light source 1. In this embodiment, the recess configuration is trapezoidal, but the effect near that obtained by the trapezoid can be obtained even if the recess configuration is semi-circular, triangular, or polygonal.

On the light output surface or the opposing surface of the light guide body 2 is formed with the reflection structural body such as a prism or a dot. The light that has entered the light guide body 2 advances while being guided in the interior of the light guide body, and then is applied to the reflection structural body, thereby allowing the light to be output from the light output surface of the light guide body 2. With the light input part 2a according to this embodiment, when the light is applied to the reflection structural body, a larger amount of components of light to be output vertically from the light output surface (in other words, in a direction of an observer) can be input into the light guide body. The light input part 2a has a function of dividing the light of the light source 1 into three directions, and converting a direction of a partial component. The light emitted from the light source 1 collides with the trapezoidal recess 2b, and is then divided into linear components 3a that are input to the light guide body 2 from the short side of the trapezoid, and substantially linearly advances as it is, and components that are refracted from two oblique sides of the trapezoid and input thereto. The components are applied to the paraboloids 2d, and most of the components are totally reflected to become reflected components 3b, and advance in the substantially same direction as that of the linear components 3a. That is, the provision of the trapezoidal recess 2b and the paraboloids 2d on the light input surface of the light input part enables the directions of light from the light sources 1 to be uniformed. A focal distance of the paraboloids 2d is about 0.5 to 0.7 mm from the light source 1. The light of the linear components 3a and the reflected components 3b is applied to the reflection structural body formed on the light guide body 2, and then output from the light output surface.

FIG. 10 schematically illustrates a main portion of the lighting device in which a lower prism is formed on the opposing surface of the light guide body as the reflection structural body. The light guide body 2 is formed with the above-mentioned light input parts 2a, whereby most of the light output from the light sources 1 becomes components perpendicular to a lower prism 5. The light in a direction perpendicular to a crest line of the lower prism 5 is reflected by the lower prism 5, and output perpendicularly from the light output surface. For that reason, the light output efficiency from the light guide body can be remarkably enhanced.

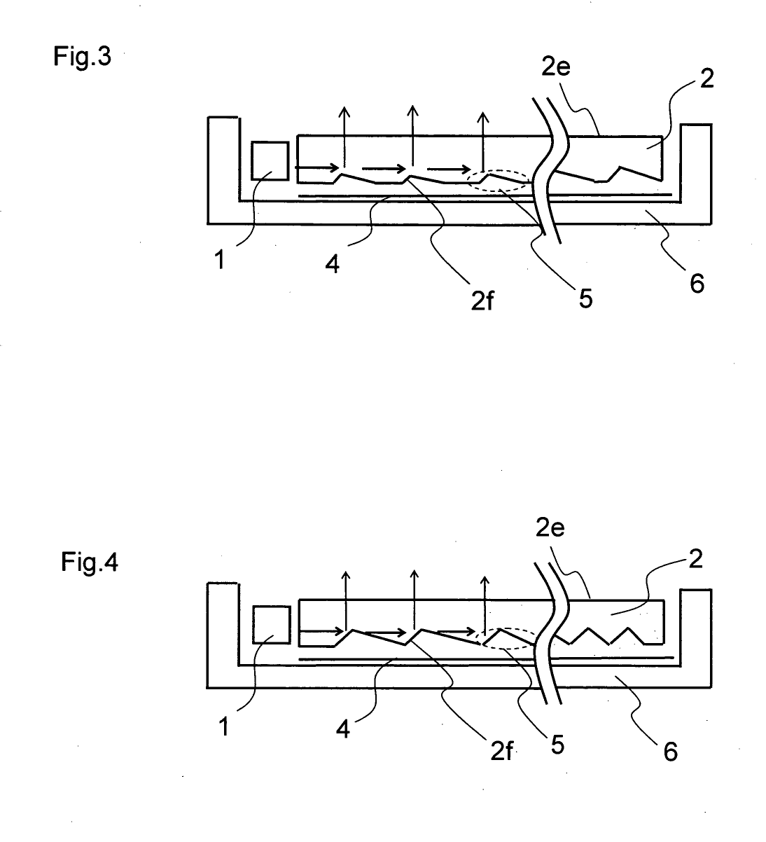

A cross-sectional configuration of the lighting device having the light guide body 2 in which the lower prism is formed is schematically illustrated in FIG. 3. The light guide body 2 has the light output surface 2e and the opposing surface, and a reflection sheet 4 is located below the opposing surface. There is frequently used the reflection sheet 4 of the type in which silver or aluminum is deposited on a transparent film such as PET, or white PET or ESR made by Sumitomo 3M Ltd., etc. A frame 6 is used to mechanically support the light source 1, the light guide body 2, and the reflection sheet 4, and to prevent leak light to improve the utilization efficiency of light. That is, the reflection sheet 4 is arranged on the frame 6, and the light guide body 2 is arranged in such a manner that a reflection surface of the reflection sheet 4 faces the opposing surface of the light guide body 2. The frame 6 is frequently formed of a resin molded article made of white polycarbonate, etc. The frame 6 may be further covered with a metal frame made of aluminum.

Each of the lower prisms 5 is a recess formed on the lower surface (opposing surface) of the light guide plate 2, and configured by at least two surfaces. One surface of those two surfaces which is closer to the light source 1 is a reflection surface 2f. The light input to the light guide body 2 from the light source 1 is divided into the linear component 3a and the reflected component 3b as described above, and collides with the lower prisms 5 perpendicularly with respect to the crest lines of the lower prisms 5. For that reason, most of the components are liable to be output from the light output surface 2e. Further, when the prism angle (angle between the reflection surface 2f of the lower prism 5 and the light output surface 2e of the light guide plate) falls within a range of from about 40 to 50 degrees, most of the components are totally reflected by the reflection surfaces 2f of the lower prisms 5 in a direction perpendicular to the light output surface 2e of the light guide plate 2. In this embodiment, pitches of the lower prisms 5 are regular, and heights thereof are variably set. The lower prisms 5 are lower toward the light sources 1 whereas the lower prisms 5 are higher departing therefrom. When the light guide plate having the prisms formed thereon and a liquid crystal panel are combined together in use, there is a case where the pitches of the prisms which are liable to interfere with dot pitches of the liquid crystal panel exist. As in this embodiment, when the pitches of the prisms are held constant, there is advantageous in that an interference with the liquid crystal panel is liable to be avoidable.

On the other hand, when one of the surfaces configuring the lower prism 5, which is spaced apart from the light source 1, is referred to as an “oblique surface”, the oblique surface hardly contributes to the output light from the light guide body 2. Under the circumstance, the manufacture of a mold is regarded as importance, and an angle formed between the oblique surface of the prism and the light output surface of the light guide plate may be made gentle, and a base of the reflection surface of the backward lower prism and a base of the oblique surface of the forward lower prism may be brought into contact with each other. With this configuration, the mold has no concave and no convex, and the manufacture is facilitated. Further, the mold manufacture can be performed by the conventional mechanical processing technique, and an increase in size is facilitated.

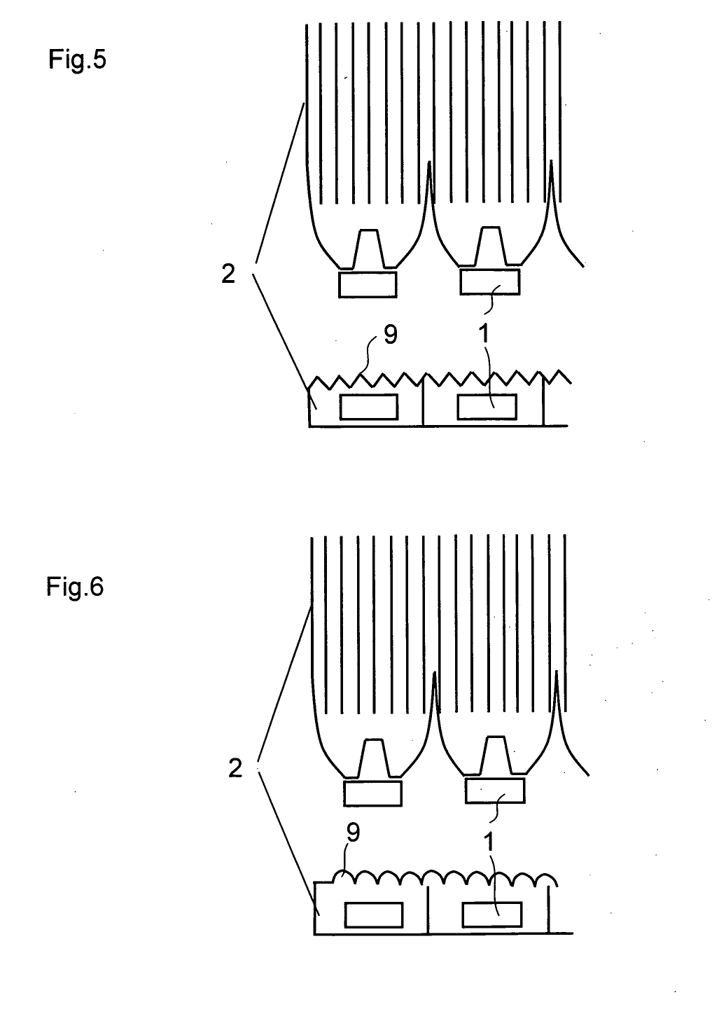

Subsequently, a configuration in which the prisms are formed on the light output surface of the light guide body 2 is schematically illustrated in FIG. 5. As illustrated in FIG. 5, upper prisms 9 having an alignment direction orthogonal to an alignment direction of the lower prisms 5 are formed on the light output surface of the light guide body 2. With the formation of the above-mentioned upper prisms 9, light unevenness and so on can be reduced. As illustrated in FIG. 5, a triangular prism is used as the upper prism 9. There is the possibility that the vertex angle of the upper prism is set within a remarkable wide range of from 40° to 170°. Basically, the high brightness is aimed at when the vertex angle is made larger, and a wide visual angle is aimed at when the vertex angle is made smaller. Further, the vertex angle is not limited to one type, but the upper prisms 9 having a plurality of vertex angles may be aligned so that the light is dispersed at various angles, which is effective in reducing the unevenness. In this case, the upper prisms 9 are formed on not only the entire surface of the light emitting part of the light guide plate 2 but also the upper surfaces of the light input parts 2a. That is, it is desirable that the upper prisms 9 be formed up to positions closest to the light source 1 wherever possible. The upper prisms 9 are formed up onto the upper surfaces of the light input parts 2a, thereby enabling the linear components 3a and the reflected components 3b to be more evenly mixed together. An optimum value of the upper prism vertex angle for evenly mixing the linear components 3a and the reflected components 3b together is frequently different from an optimum value of the upper prism vertex angle for reducing the unevenness of the upper surface of the light guide plate 2. For that reason, it is more preferable that the upper prism configuration disposed on the upper surface (light guide body 2 of a site closer to the light source 1) of the light input parts 2a, and the upper prism configuration disposed on the effective light emitting part of the light guide body 2 be optimized, individually. That is, the vertex angles of the prisms formed on the upper surface of the light input part closer to the light source are set so as to uniform the directions of light output from the light input parts, and the vertex angles of the prisms formed on the upper surface of the light emitting part are set so as to reduce the unevenness of the light output surface.

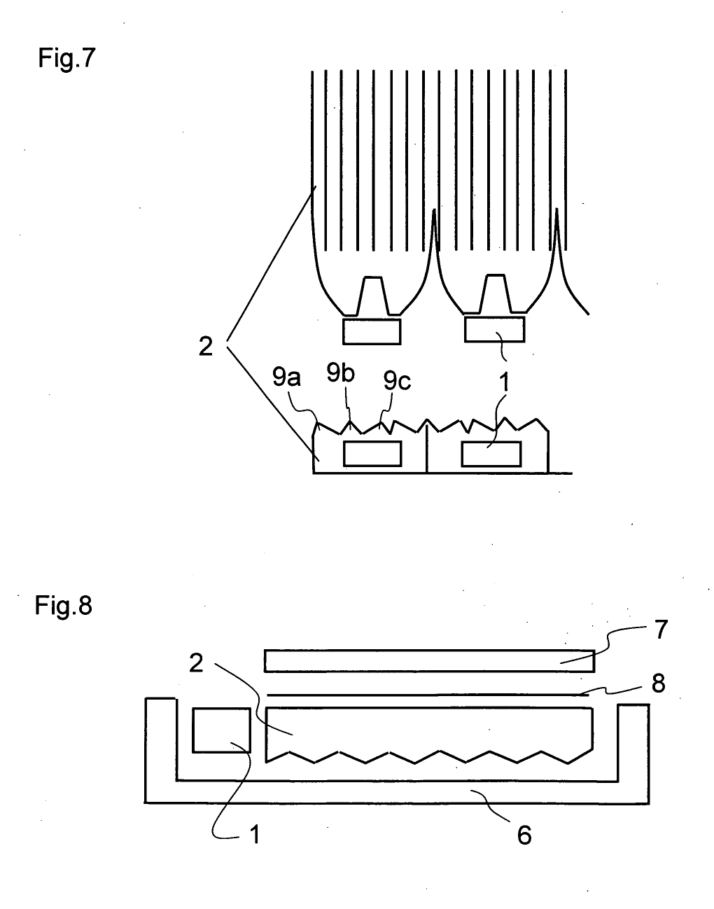

FIG. 8 illustrates a cross-sectional view of a display device with the lighting device according to this embodiment. The light from the light source 1 is input to the light guide body 2, and output from the light output surface by the lower prisms disposed in the light guide body 2 to light the liquid crystal panel 7. The light guide body 2 is covered with the frame 6, thereby enabling display with remarkably high brightness to be realized. Here, a diffusion film 8 is arranged on the light guide body 2, but is not an essential component. Alternatively, a plurality of the diffusion films 8 may be arranged, or a BEF sheet made by Sumitomo 3M Limited, a prism sheet made by Mitsubishi Rayon Co., Ltd., or the like may be arranged on the diffusion film.

### Second Embodiment

A cross-sectional configuration of a lighting device according to this embodiment is schematically illustrated in FIG. 4. A difference in configuration from FIG. 3 described in the first embodiment resides in that the height of the lower prisms is held constant, and the pitches thereof are narrower as the lower prisms are away from the light source 1. When a design is made so that the height is variable as in the first embodiment, there is a case where the height of the lower prism 5 must be made extremely small depending on the thickness or size of the light guide body 2. In the case of the present machining process, the limit value of the controllable prism height is about 1 μm. When the height that is lower than the limit value is required, as illustrated in FIG. 4, the pitches must be made variable. In that case, there is the fear that the prisms with specific pitches interfere with the pixel pitches of a liquid crystal panel, and stripes caused by moiré occur in a specific area, and hence the design must be carefully made.

Further, in this embodiment, the lighting device is formed in such a manner that an angle formed between the oblique surface of each prism and the light output surface of the light guide plate is made gentle, and the base of the reflection surface of the backward lower prism is brought in contact with the base of the oblique surface of the forward lower prism. With the above-mentioned configuration, the mold has no concave and no convex, and the lighting device is readily fabricated even with small prism pitches.

### Third Embodiment

A part of the configuration of a lighting device according to a third embodiment is schematically illustrated in FIG. 6. The configuration of FIG. 6 is different from the configuration of FIG. 5 described in the first embodiment in that each upper prism 9 is not a triangular prism but a semi-circular prism. In the case of the semi-circular prism, as compared with the triangular prism, the directions in which the light is scattered are not stepwise, resulting in the possibility that unevenness is further reduced. When the center position of the semi-circle is taken away from the light guide plate 2, the visual angle is emphasized, and when the center position thereof is made closer to the light guide plate 2, the brightness is emphasized. In this embodiment, the semi-circle is of a convex configuration, but even if the semi-circle is of a concave configuration, the same effect is obtained.

### Fourth Embodiment

A part of the configuration of a lighting device according to a fourth embodiment is schematically illustrated in FIG. 7. The lighting device illustrated in FIG. 7 is different from the lighting device illustrated in FIG. 5 according to the first embodiment in that three kinds of upper prisms different in cross-sectional configuration, that is, an upper prism 9a, an upper prism 9b, and an upper prism 9c are formed on the light output surface. The cross-sectional configuration of the upper prism 9a is a triangle that is 110° in the vertex angle, and 45° and 25° in the base angle. The cross-sectional configuration of the upper prism 9b is an isosceles triangle that is 110° in the vertex angle, and 35° in the base angle. The cross-sectional configuration of the upper prism 9c is a triangle that is 110° in the vertex angle, and 45° and 25° in the base angle. The upper prism 9c is symmetrically arranged with respect to the upper prism 9a. The arrangement of the plurality of upper prisms different in the cross-sectional configuration enables an increase in directions in which the light is scattered, and an improvement in uniformity of the surface light source.

Further, in this embodiment, the vertex angle of each upper prism is set to 110°, the same effect is obtained when the vertex angle of each upper prism falls within a range of from 100° to 140°. Further, the vertex angles of the respective upper prisms are not necessarily identical with each other, but, for example, three kinds of upper prisms that are 100°, 120°, and 140° in the vertex angle, respectively, may be prepared. Further, the scattering effect is higher as the number of the kinds of upper prism configurations are increased more. For that reason, when the higher scattering effect is necessary, it is preferable to arrange four or more kinds of upper prisms. Further, three or more kinds of upper prisms are not always necessary, but even two kinds of upper prisms can provide a certain degree of scattering effect.

Further, the heights of the upper prisms are larger in an area closer to the light source, and made smaller as the upper prisms are away from the light source. As a result, light scattering is strengthened in the area closer to the light source where brightness unevenness is most liable to occur, and light scattering is weakened in the area departing from the light source where brightness unevenness is difficult to occur, thereby enabling the brightness of the lighting device to be increased.

### Fifth Embodiment

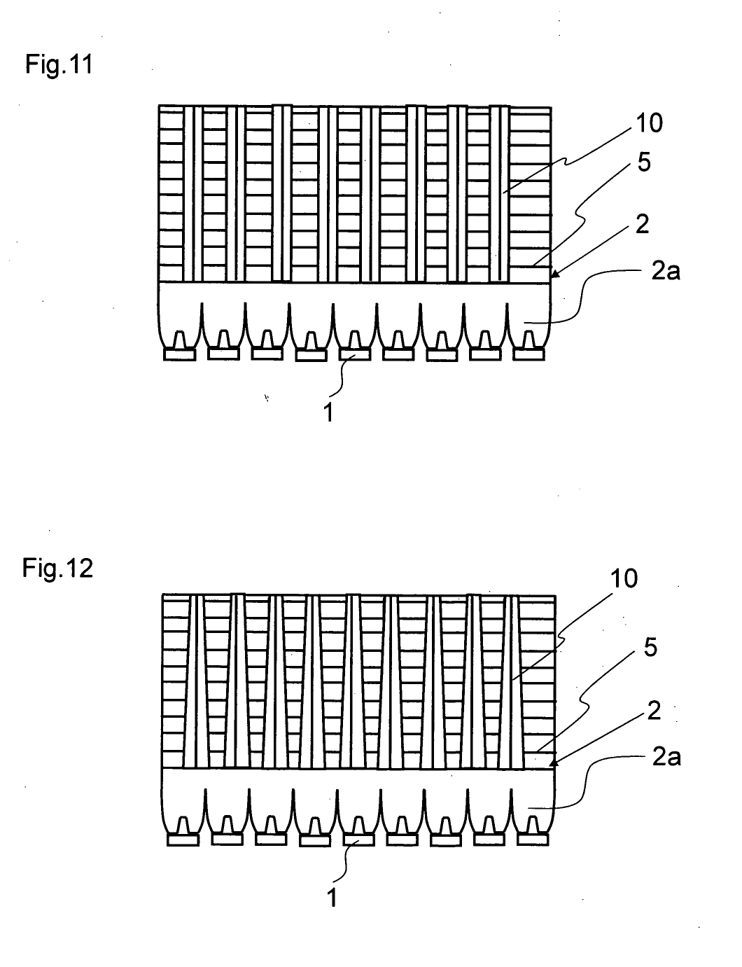

A lighting device according to a fifth embodiment is schematically illustrated in FIGS. 11 and 12. FIG. 11 is a rear view of the light guide body 2, that is, a view taken from the opposing surface side. On the opposing surface of the light guide body 2 is formed the lower prism 5 that reflects light from the light source and outputs the light in the vertical direction. As illustrated in FIG. 11, vertical prisms 10 are formed on the opposing surface in a direction orthogonal to the lower prisms 5. Each vertical prism 10 has a longitudinal side thereof in the light output direction of the light source, and is formed in a convex configuration on the opposing surface. The formation of those vertical prisms 10 enables the size (depth/height) of the lower prisms 5 to be increased. In general, when the backlight of the prism type is combined with the liquid crystal panel, light unevenness called “moiré” is liable to occur. As countermeasure against this drawback, the pitches of the lower prisms formed on the opposing surface can be reduced as much as possible as compared with the dot pitches of the liquid crystal panel. More specifically, the lower prism pitches of the backlight need to be about ⅓ or lower of the dot pitches of the liquid crystal panel. In order to thus reduce the pitches of the lower prisms for keeping the uniformity of brightness, the size (height) of the lower prisms needs to be reduced. However, when the height of the lower prisms is made excessively small, the optical design based on the Snell's law is difficult, and the lower prisms per se do not function. In general, light includes particles having wave components, and the wavelength of the visible light is about 400 nm to 700 nm. When the lower-prism size becomes smaller, the wave property of light is emphasized, and thus the Snell's law tends not to be established. For that reason, when the height of the prisms is about 10 μm, the prism effect of light is reduced.

Under the above-mentioned circumstance, in this embodiment, the vertical prisms 10 being in parallel to the light output direction of the light source 1 is formed on the opposing surface of the light guide body 2 so as to be orthogonal to the lower prisms 5. As a result, the pitches of the lower prisms can be reduced while the size of the lower prisms 5 is kept.

Hereinafter, the effect when the vertical prisms 10 are formed is described. Here, it is assumed that a length of the reflection surface of the lower prisms 5 is a length of the reflection surface of the lower prisms 5 in the vertical direction (a length of the oblique side extending from the base of the lower prism 5 to the vertex angle thereof). Further, it is assumed that a width of the reflection surface of the lower prisms 5 is a length of the base of the reflection surface, which is perpendicular to the light output direction of the light source 1. Further, it is assumed that a width of the vertical prisms 10 is a length of the base perpendicular to the light output direction of the light source 1.

It is assumed that on the opposing surface of the light guide body 2 are formed ten lower prisms 5 in total, which are 100 μm in the pitches and 10 μm in the length of the reflection surface. When it is assumed that the width of the reflection surface of the lower prisms 5 is W, a total area of the reflection surfaces of the lower prisms 5 is a product of the width W of the reflection surface of each prism 5, the length of the reflection surface thereof, and the number of lower prisms, and therefore 100 Wμm². If it is assumed that the pitches of the lower prisms 5 are 50 μm, it is necessary to increase the total number of prisms to 20. Further, in order to keep the total area of the reflection surfaces of the lower prisms 5 to 100 Wμm² under that condition, it is necessary to reduce the length of the reflection surface to 5 μm. However, when the length of the reflection surface is shortened, the size of each lower prism 5 is reduced, and the wave property of light is emphasized as described above, with the result that the optical design is difficult. Under the circumstance, the vertical prisms 10 are formed so as to be orthogonal to the lower prisms 5. It is desirable that the vertical prisms 10 be formed at regular pitches. Here, it is assumed that the width of the vertical prisms 10 is 50 μm, and the pitches are 100 μm. With the formation of the vertical prisms 10 as described above, the total width of the lower prisms 5 is reduced by half, and hence, even if the length of the reflection surface of the lower prisms 5 is kept to 10 μm, the total area of the reflection surfaces of the lower prisms 5 is 100 Wμm² without being changed. In this way, the vertical prisms 10 have a function of controlling the total area of the reflection surfaces of the lower prisms 5 being the reflection structural body.

In this embodiment, the cross-sectional configuration of the vertical prism 10 is triangular. This is because the triangle is easily manufactured from the viewpoint of the mechanical processing, and the same optical effects as triangle are obtained by a semi-circle and polygons of rectangle or more. Further, in this embodiment, the configuration of the vertical prisms 10 is of the convex configuration for convenience of processing, but the same effect is obtained even by a concave configuration.

FIG. 12 illustrates a rear view of the light guide body 2 in which vertical prisms 10 different in configuration from those of FIG. 11 are formed. In FIG. 11, the height of the vertical prisms 10 is held constant whereas in FIG. 12, the height of the vertical prisms 10 is lower and the width thereof is narrower as the vertical prisms 10 are away from the light source 1. As a result, the cross-sectional configuration of the vertical prisms 10 is gradually smaller.

In general, the components of light to be output are reduced as the light is away from the light sources 1. For that reason, in order to efficiently use the components of light for outputting the light from the light sources 1, it is necessary that the reflection area of the lower prisms 5 is made larger as the lower prisms 5 are away from the light sources 1. As illustrated in FIG. 12, as the vertical prisms 10 depart from the light sources 1, the height of the vertical prisms 10 is made lower, and the width thereof is made shorter to reduce the cross-sectional area of the vertical prisms 10, thereby making the width of the reflection surface of the lower prisms 5 longer, and enabling the reflection area of the lower prisms to increase. With the above-mentioned structure, it is easy to upsize the lighting device.

### Sixth Embodiment

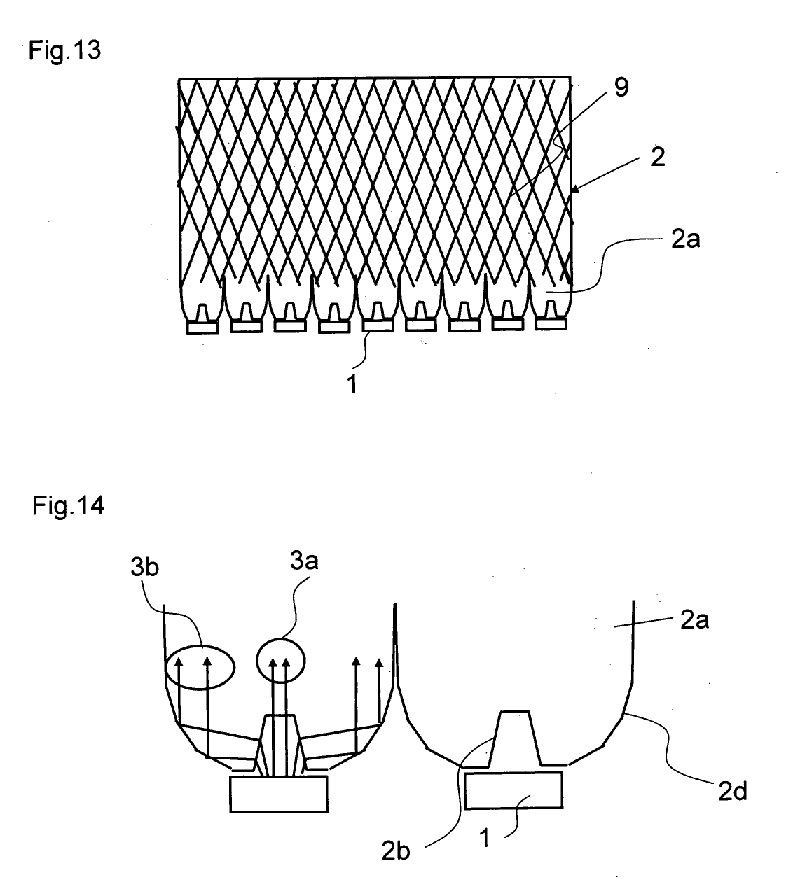

A lighting device according to a sixth embodiment is schematically illustrated in FIG. 13. On the light output surface of the light guide body 2 are formed the upper prisms 9. In the first to fourth embodiments, the upper prisms 9 are formed in parallel to the light output direction of the light sources 1 whereas in this embodiment, the upper prisms 9 are formed so as to provide two kinds of angles with respect to the light output direction of the light sources 1. As illustrated in FIG. 13, the upper prisms 9 are formed alternately at an angle of about 5 to 30 degrees with respect to the light output direction of the light sources 1. As a result, the respective upper prisms 9 cross each other, and such a configuration that a large number of longitudinal parallelograms are arranged is formed on the light output surface. With the formation of the upper prisms as described above, the light output from the light output surface of the light guide body can be scattered, and moiré occurring when the lighting device is combined with the liquid crystal panel can be unremarkable.

### Seventh Embodiment

A light input part of a lighting device according to a seventh embodiment is described with reference to FIG. 14. In the light input part of the first embodiment illustrated in FIG. 2, the paraboloid 2d is formed of a curved surface. In this embodiment, the paraboloid 2d is formed of not the curved surface but a plurality of flat surfaces which are combined with each other at angles into a polygonal configuration. As in this embodiment, the paraboloid 2d is formed in the polygonal configuration, thereby enabling light distribution to be freely controlled, and the lighting device with higher brightness and with higher uniformity to be realized.

In the above-mentioned respective embodiments, a white LED of the side view type is used for each light source 1, but there may be applied another point light source, for example, an LED of the top view type or a bombshell type, or a light source of a color other than white. Further, the light guide body 2 is a mold product made of a transparent resin such as Zeonor, PMMA, or PC.

The lighting device according to the present invention can be applied to a display device for a cellular phone, a PDA, a car navigation system, or a television set. Further, the lighting device according to the present invention can also be applied to equipment lighting for housings, offices or the like.

What is claimed is:

1. A lighting device, comprising:
a light guide body which includes a light input part and a light emitting part, and guides a light input from a light input surface of the light input part to output the light from a light output surface of the light emitting part;
a light source which outputs the light to the light input surface; and
a recess formed on the light input surface so as to face the light output part of the light source,
wherein the light input part has the light input surface, and a paraboloid extending in a radial pattern in a light output direction from a light output part of the light source.

2. A lighting device according to claim 1, further comprising a plurality of prisms formed on the light output surface in a direction orthogonal to the light input surface.

3. A lighting device according to claim 1, further comprising a plurality of prisms formed on the light output surface so as to cross each other.

4. A lighting device according to claim 2, wherein each of the plurality of prisms has a cross-sectional configuration of a triangle having a vertex angle falling within a range of from 40° to 170°.

5. A lighting device according to claim 4, wherein the plurality of prisms having different vertex angles are arranged.

6. A lighting device according to claim 2, wherein each of the plurality of prisms has a cross-sectional configuration of a semi-circle.

7. A lighting device according to claim 2, further comprising the plurality of prisms formed on the light input part,
wherein the plurality of prisms formed on the light output surface of the light emitting part and the plurality of prisms formed on the light input part are different in configuration from each other.

8. A lighting device according to claim 1, wherein the recess has a configuration of any one of a triangle, a semi-circle, and a polygon of a rectangle or more.

9. A lighting device according to claim 1, further comprising reflection structural bodies formed on a lower surface of the light guide body at regular pitches,
wherein heights of the reflection structural bodies are increased as the reflection structural bodies are spaced apart from the light source.

10. A lighting device according to claim 1, further comprising reflection structural bodies having the same height formed on a lower surface of the light guide body,
wherein pitches of the reflection structural bodies are reduced as the reflection structural bodies are spaced apart from the light source.

11. A lighting device according to claim 9, further comprising a structure for suppressing a total area of reflection surfaces of the reflection structural bodies, which is formed on the lower surface of the light guide body.

12. A lighting device according to claim 11, further comprising a plurality of the structures arranged at given pitches.

13. A lighting device according to claim 11, wherein the structure has a smaller cross-sectional area as the structure is spaced apart from the light source.

14. A lighting device according to claim 11, wherein the structure includes a vertical prism having a long side in the light output direction of the light source.

15. A lighting device according to claim 1, wherein the paraboloid has a polygonal configuration formed of a plurality of flat surfaces which are combined at angles with each other.

16. A display device, comprising:
a light guide body which includes a light input part and a light emitting part, and guides a light input from a light input surface of the light input part to output the light from a light output surface of the light emitting part;
a light source which outputs the light to the light input surface;
a display element which performs display by using the light output from the light output surface; and
a recess formed on the light input surface so as to face the light output part of the light source,
wherein the light input part has the light input surface, and a paraboloid extending in a radial pattern in a light output direction from a light output part of the light source.
